(19) United States
(12) Patent Application Publication
(10) Pub. No.: US 2020/0297067 A1
(43) Pub. Date: Sep. 24, 2020

(54) VIBRATING SNEAKERS WITH MINI SIT DOWN LEG EXERCISER CONNECTION

(71) Applicant: JULIET PAMELA GRAHAM, Staratford, CT (US)

(72) Inventor: JULIET PAMELA GRAHAM, Staratford, CT (US)

(21) Appl. No.: 16/802,525

(22) Filed: Feb. 26, 2020

Related U.S. Application Data
(60) Provisional application No. 62/919,120, filed on Feb. 26, 2019.

(51) Int. Cl. A43B 7/14; A43B 3/00; A63B 21/00; A63B 21/04; A63B 21/055; A61H 9/00; A61H 15/00; A61H 23/00; A61H 23/02; A61H 39/04; A43B 7/04

(52) U.S. Cl. CPC A43B 7/146; A43B 3/0005; A63B 21/4015; A63B 21/04; A63B 21/0552; A61H 9/005; A61H 2201/164; A61H 23/006; A61H 23/02; A61H 39/04; A43B 7/04; A61H 2201/0207; A61H 2201/165; A61H 15/0078

(57) ABSTRACT

Disclosed is an apparatus and method for exercising, strengthening, energizing and relieving portions of the body. The invention is the combination of the Vibrating, Massaging Sneakers interconnecting with the Mini Sit Down Leg Exerciser Connection with Adjustable/Stretchable hand held exercising cords together creates a Full Body mini exercising device that enhances health, fitness and wellness. The Sneakers are equipped with varying Massage Types and Intensity, including Heating Therapy, Air Compression, Bi-Directional Rolling/Kneading apparatus, with small vibrators/massagers embedded in the Therapeutic Compartments of Sneakers, to provide maximum effect to various Pressure Points of user's feet. The inter-connectable Leg Exerciser with Adjustable, Stretchable Hand held Exercising Cords provides added benefits of toning and strengthening the User's upper body, arms, legs, ankles, and feet, creating a Full Body Exercising Mechanism. Benefits to users of the invented, are relief from aches, pains, muscular buildup, stimulation of circulation, stress, overall improvements.

### BACKGROUND

### (A) Field of the Invention

This invention is directed/relates generally to the health and wellness and exercise field, especially for those in need of soothing, strengthening, rejuvenation and various kinds of relieves.

### (B) Background

There are various vibrating and exercising devices that are available to date. However, there remains a continuing need for which this Vibrating Sneakers with Mini Sit Down Leg Exerciser Connection will be the solution for the relevant consumer audience.

### BRIEF SUMMARY

I have invented a new, original, non-obvious, useful and ornamental product for the purpose of health, fitness and wellness.

The designed is an apparatus/device and method for exercising, massaging, stimulating, energizing and strengthening various portions of the body, especially the legs and feet.

Among the many benefits to the users of the invented, are relief from aches and pains, muscle cramps, tiredness, strengthening, stimulation of circulation, balance and other needed enhancements. Benefactors of the invented includes, but are not limited to, long sitting office workers, the elderly, athletes, the fatigued and many more.

Located in our feet are pressure points to all the organs of our bodies. The Vibrating Sneakers works on every areas of the feet to benefit the user in entirety, through massaging all the nerve points in the user's feet; which will in turn benefit all the vital parts of the body up to the brain. Massage produces a chain reaction in the body that results in a better health condition for the user; soothing muscle aches and pain, and assisting in the regeneration of other conditions.

It revives tired feet and warms cold feet. The invented will aid with reducing stress and anxiety levels, improves circulation, relaxes and strengthens ankle and leg muscles, especially for those who are elderly and the athletic.

The Vibrating Sneaker that supplies various kinds of massaging therapy, coupled with the Mini Sit Down Leg Exerciser Connection and adjustable/stretchable hand held exercising cords will improve the health/hygiene and appearance of the user's feet, and provide overall rejuvenation to the body.

### DETAILED DESCRIPTION OF THE INVENTION

The invented is the combination of the Vibrating Sneaker interconnecting with the Mini Compressible Exerciser and adjustable/stretchable hand held exercising cords to create a mini exercising mechanism.

These inventions may be embodied in different forms. They should not be construed as being limited to the embodiments set forth herein

The disclosures are for exemplifying the invention, and not for limiting the invention to the specifics of the illustrations described below;

Some, but not all embodiments of the invention are shown in these figures.

The massaging sneakers has an extra Inner Lining created with bumpy raised patches outlining the various pressure points of the feet for added effect. It is a strong protective cushioned fabric, designed to be removable/washable for easy cleaning, odor control and for health/hygiene purposes.

The “Outer/Upper Layer” is created out of Canvas and/or Nylon Fabrics, for strength, durability, comfort, and flexibility. Vibrating Devices are also dispersed in selected areas of the Upper Layer of the Sneakers for maximum massaging effect.

The vibration therapy includes Air Compression/Acupressure, Rolling/Kneading, Percussion, and Heat Therapy Massages. The Vibrating Sneaker is equipped with varying Massage Types and Intensity Settings, which provides the user with the ability to choose, including Auto Programs and User's own personalized programmed Choice.

The operative parts of the sneaker is located within the Therapeutic Compartment, located within the well-like cavity inside the bottom layer of the sneakers, and extends to the pertaining portion of the upper portion of the sneakers. It includes the Heating Elements, the Air Compression/Acupressure Motor, the Bi-Directional wavy element, and the stimulating vibration coins.

The Manual Control unit wraps around the top neck portion of the sneaker and consist of all operable selections. As well as, the sneaker has both auto and manual working abilities, and is also controlled via wireless remote control and a massage app for modernized electronic connections.

The Vibrating/Massaging Sneaker and the Mini Sit Down Leg Exerciser is securely connected through the use of inter-connectable locking devices. The Mini Sit Down Leg Exerciser Connection may be utilized in a Flat Position, or may be used in an adjusted, angled position of various degrees to enhance the desired muscle conditioning.

The Stretchable Hand Held Exercising Cords are built into the Mini Exerciser for a full body exercise experience.

FIG. 1 is an example of a side profile view of the vibrating sneakers and the elements comprised within and on the outside of the sneakers; which includes the placement of the vibrating devices, the lead wires, the charging connection, as well as the security for interconnecting with the mini compressible exerciser. (See 201,202,203,204,205,206,207,207,209,210,211A,212, and 213)

FIG. 2 illustrates a view of the placement of the Therapeutic Compartment of the sneaker (See 207 and 209)

FIG. 3 depicts a flat view of the hidden middle portion with the lead wires, the heating elements and the vibrators, that is within the Therapeutic Compartment between the top inner layer and the bottom inner layer of the composite material. (See 206,209, 216, 217 and 218)

FIG. 4 is a view of the Bi-Directional wavy element, that is within the Therapeutic Compartment between the top inner layer and the bottom inner layer of the composite material. (See 209, 215)

FIG. 5 illustrates the connections of the combined elements that is the make-up of the Therapeutic device, situated in the Therapeutic Compartment that in within the well-like middle portion of the bottom of the sneakers (See 206, 209, 215, 216, 217,218 and 219)

FIG. 6 is a view of the positioning of the elements inside the Therapeutic compartment (See 209, 214, 215, 216, 217 and 219)

FIG. 7 illustrates a combined view of the connected vibrating sneakers and the mini compressible exerciser. Each of the components has individual benefits.

The designed is an apparatus and method for exercising portions of the body.

Among other benefits, it provides the means of stimulating and energizing and strengthening the legs, the feet, and various body portions.

(See 201,202,203,204,205,206,207,208,209,210,211A,211B,212,213,220 and 225)

FIGS. 8 & 9. are diagrams of the side/top view of the mini compressible apparatus.

The mini exerciser is compressible by coiled springs with optional height adjustable rear springs to allow for change in positioning, and an outer non-breakable composite covering

A secure grainy composite material layers the top and a skid resistant rubber material at the bottom. There are inter-connectable locking devices on the top. (see 220, 221,222,223,224)

FIG. 10. illustrates the top view of the Mini Leg Exerciser and the connect-ability of the vibrating sneakers. (See 211B,220 and 225)

FIG. 11 depicts an angled view of the Mini Leg Exerciser for the user's repositioning to different muscle conditioning during work-out. (See 211B,220,222,223 and 226)

This invention is an apparatus for relieving aches and pains, muscle cramps, tiredness, and for stimulation of circulation in regions of the entire body, especially the legs and feet.

### BRIEF DESCRIPTION OF THE DRAWING

The accompanying drawings are not necessarily drawn to scale.

Embodiments of the invention are illustrated as examples and are not limited by the figures of the accompanying drawings.

FIG. 1 illustrates a side view of the sneakers and contents

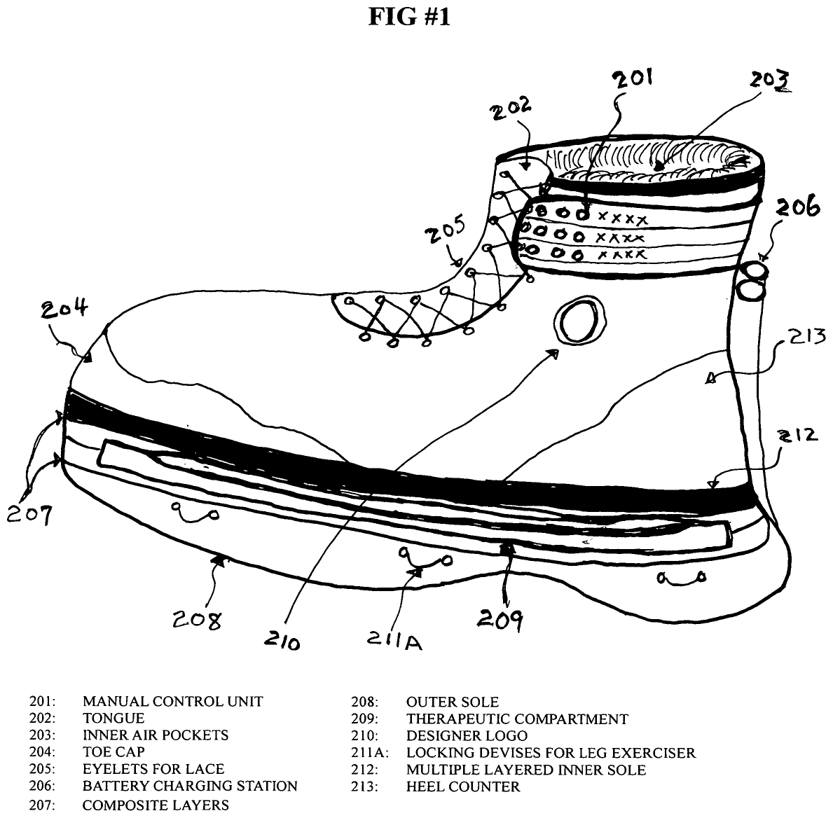

FIG. 2 illustrates a view of the placement of the Therapeutic Compartment

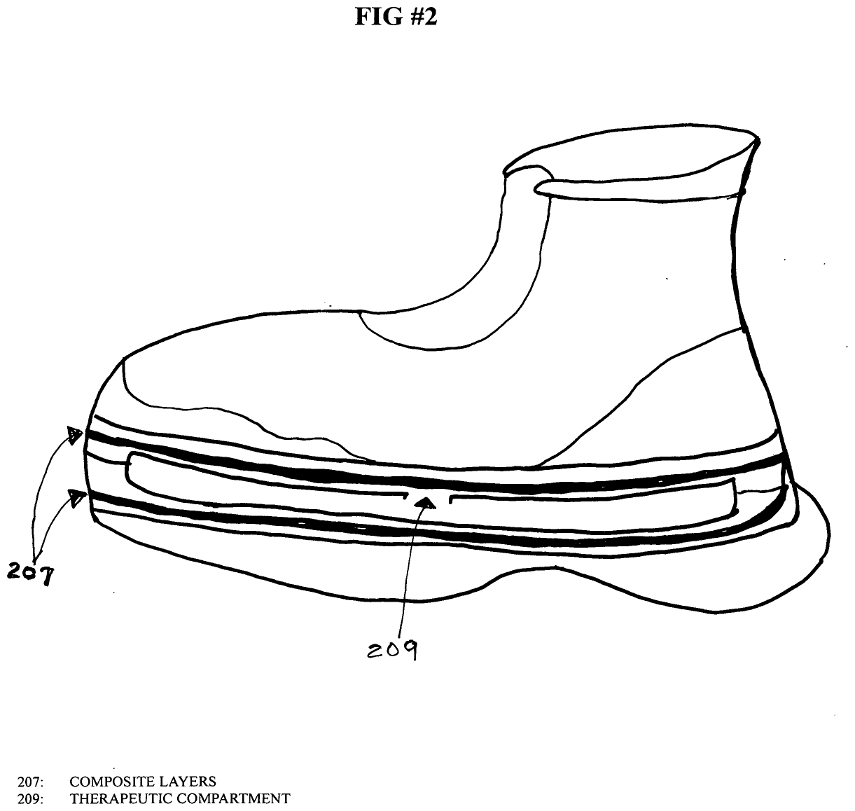

FIG. 3 illustrates a flat view of the vibrating and heating elements.

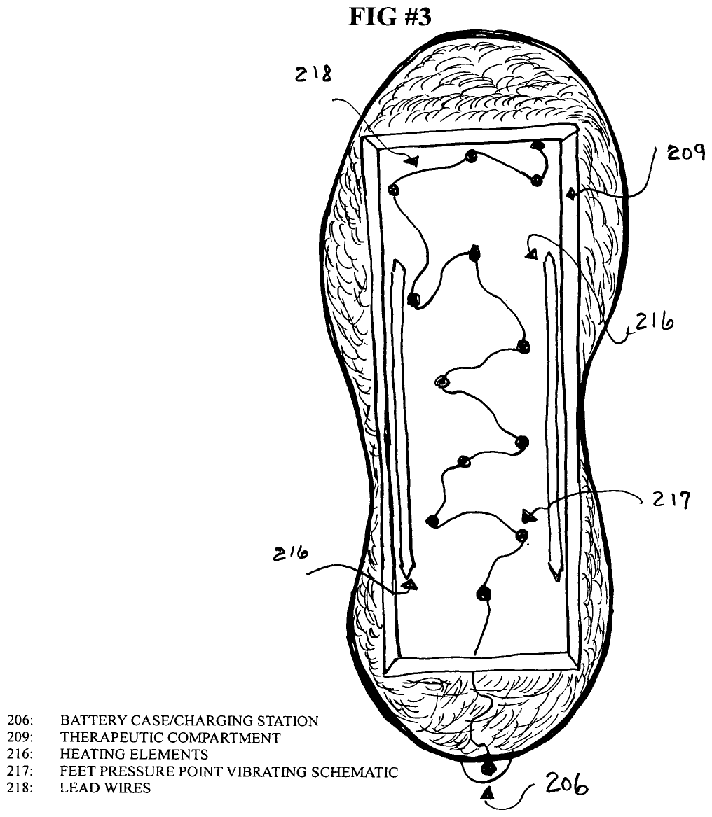

FIG. 4 illustrates a view of the Bi-Directional wavy rolling element.

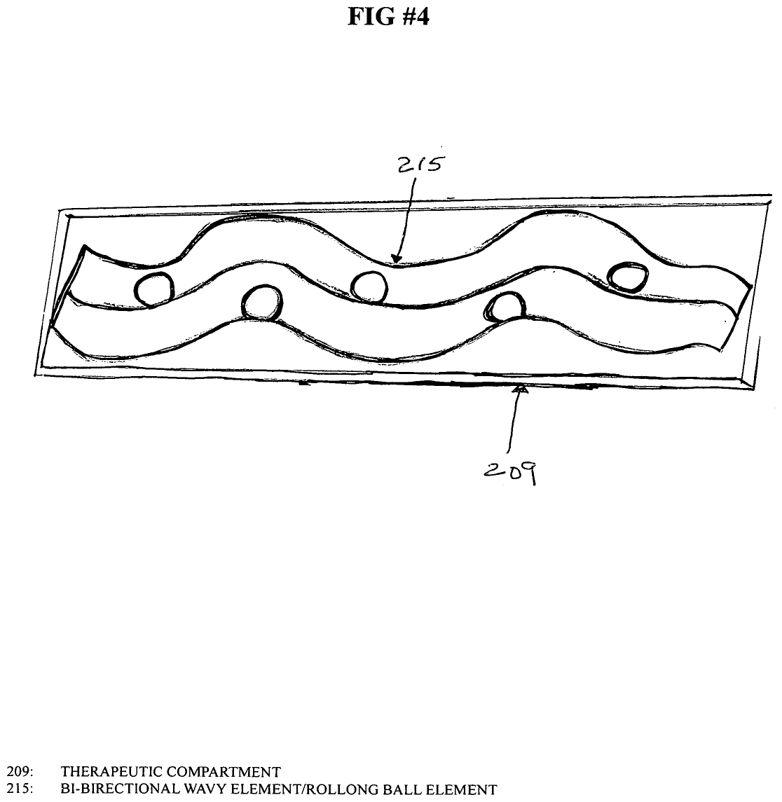

FIG. 5 depicts a combined view of the elements within the Therapeutic compartment.

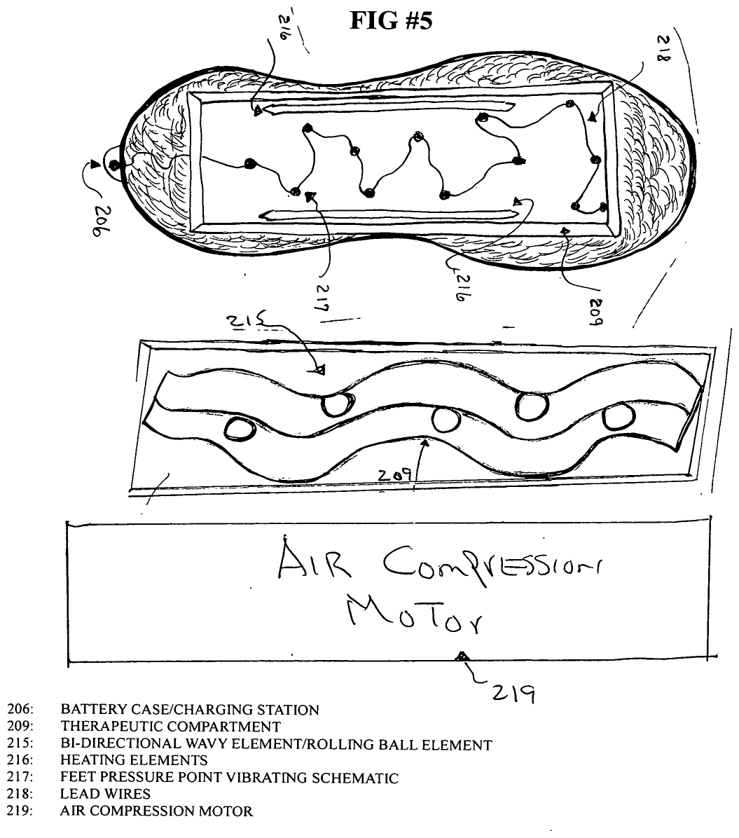

FIG. 6. illustrates the positioning of elements of which the Therapeutic device consists

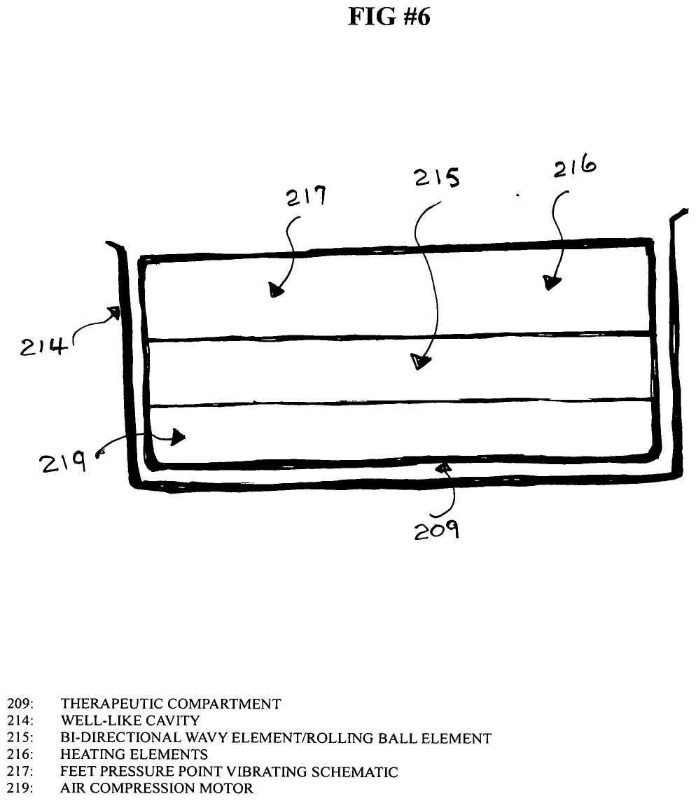

FIG. 7 illustrates a combined view of the connected vibrating sneakers and the mini compressible exerciser

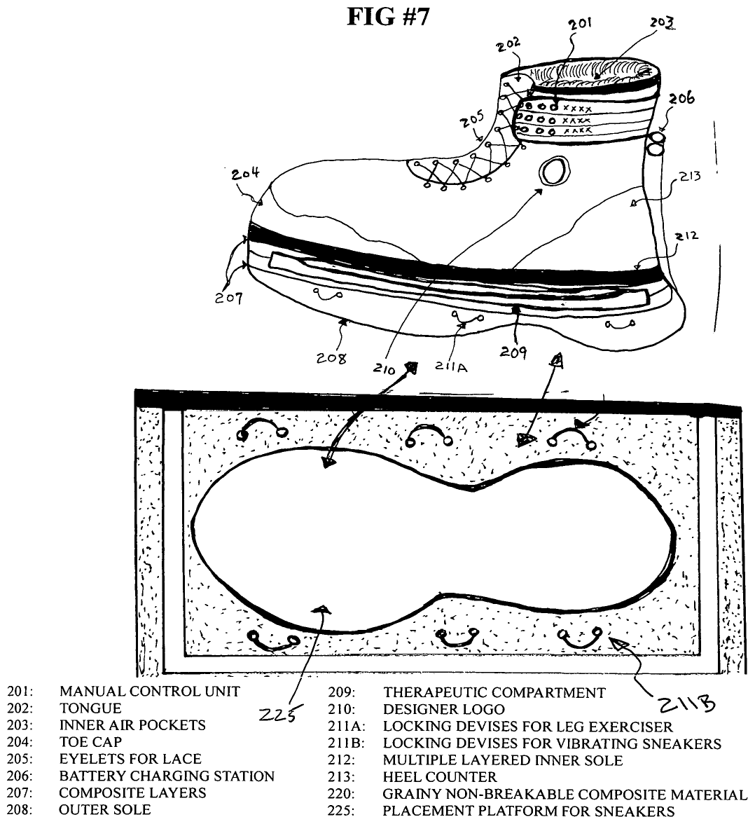

FIG. 8 illustrates the side view of the mini compressible exerciser

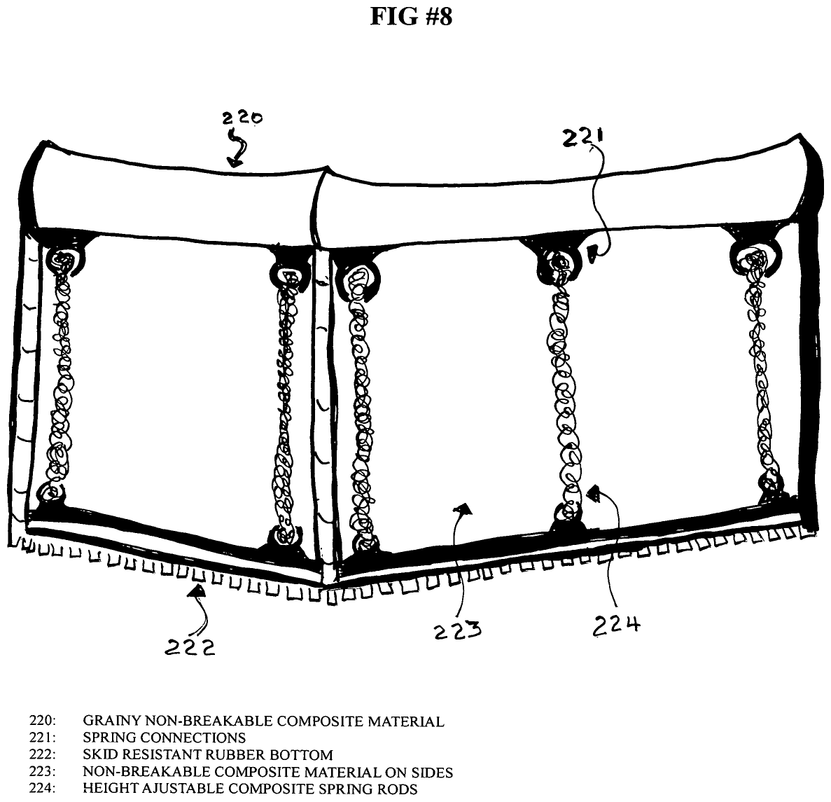

FIG. 9 illustrates the side view of the mini compressible exerciser

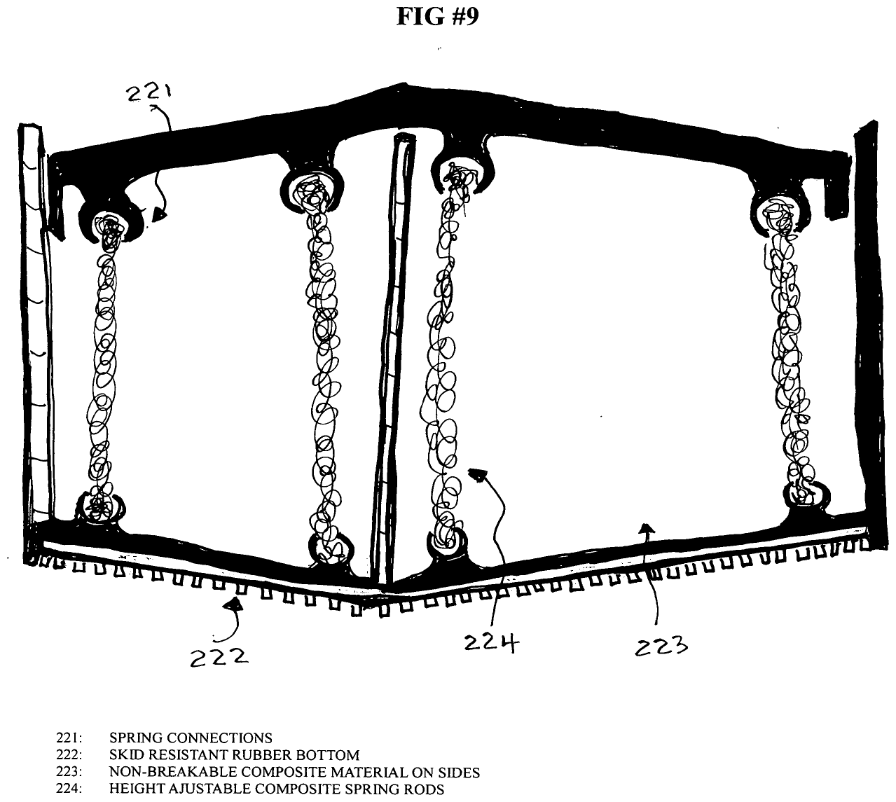

FIG. 10 illustrates the top view of the Mini Leg Exerciser and vibrating sneakers connection.

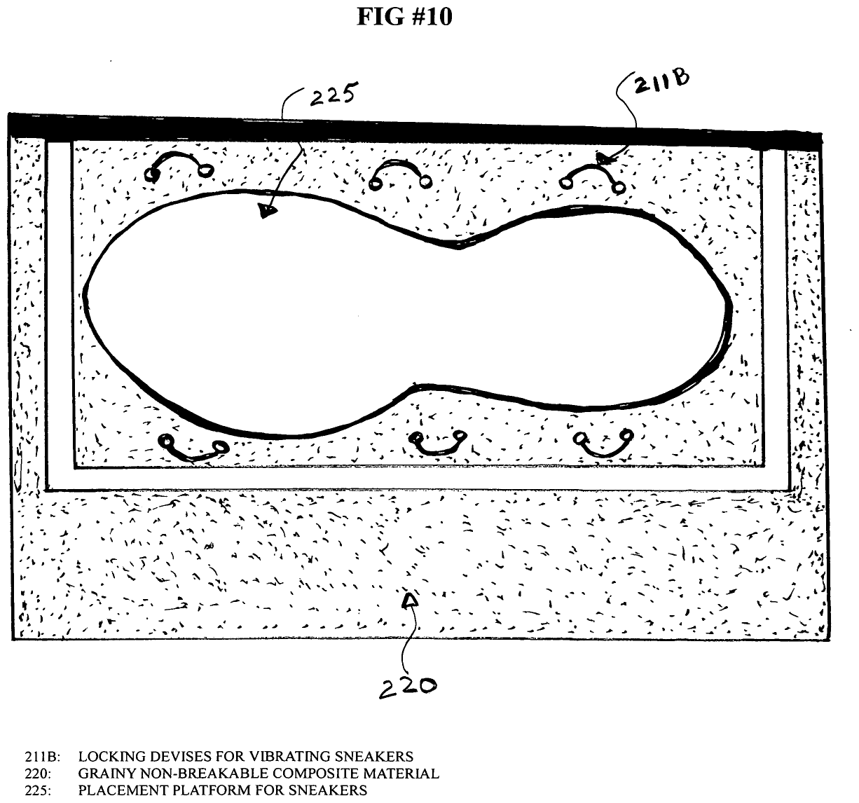

FIG. 11 illustrates an angled view of the Mini Leg Exerciser.

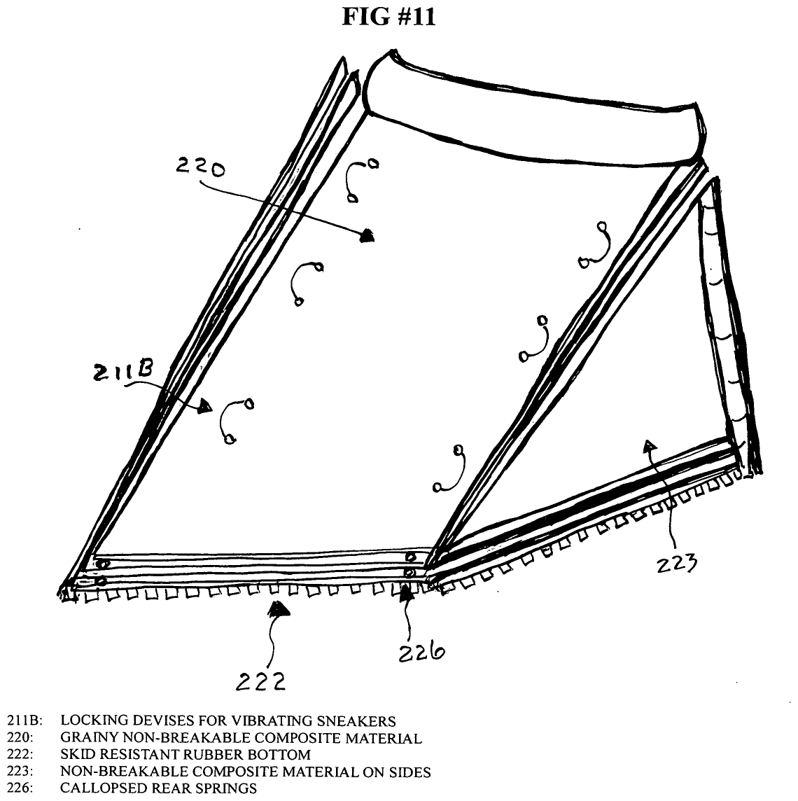

### CONCLUSION

Be it known that many verifications and modifications of the disclosed embodiments may affect the spirit and scope of the described invention

### CLAIMS

The embodiments of the invention in which an exclusive property or privilege is claimed are defined as follows: A mini exercising device; comprising of:
A Vibrating, Massaging Sneaker for stimulation, relaxation, and more.
An Inter-connectable Mini Compressible Exerciser for increased effectiveness to the required results.
Includes the vibrating devices built into the sneakers and compressible springs built within the inter connectable exerciser with adjustable/stretchable hand held exercise cords.

What I claim is:

1. The invention of a combined Vibrating, Massaging Sneaker interconnecting with a Mini Compressible Leg Exerciser that produces a Mini Full Body Exercising Mechanism.

2. The Vibrating, Massaging Sneakers as is claimed in claim 1 is a foot Massager & Circulation machine, that is inter-connectable with the Leg Exerciser Apparatus, and the Adjustable, Stretchable Hand held Exercising Cords, to create a Multi-Unit, Full Body Exercising Mechanism.

3. The Mini Sit Down Leg Exerciser: as is claimed in claim 2 interconnects with the Vibrating, Massaging Sneakers for the added benefits of toning and strengthening the User's upper body, arms, legs, ankles, and feet.

4. The Vibrating Sneakers as is claimed in claim 1 is equipped with a Therapeutic Compartment Device located in a well-like cavity within the bottom layer of each Sneaker.

5. The Vibrating, Massaging Sneakers as is claimed in claim 4 consist of two protective layers of non-breakable light weight, composite material, that is located above and below the Therapeutic Compartment Device with a wide opening in the center of the Top layer, to unhinder the effects of the massage.

6. The Vibrating, Massaging Sneakers as is claimed in claim 4 has a Heating Element inside the Therapeutic Compartment that is used to supply surrounding heat function throughout the Sneakers, which is positioned on each side of the Vibration Coins, above the Compartment Motor and the Rolling Ball elements, and provides three levels of varying temperature adjustments.

7. The Vibrating, Massaging Sneakers as is claimed in claim 2 has a Timer Control Settings with multiple Auto Shut-Off timing options for safety, and the Heating Element is built with an Overheat Protection feature, and encompasses up to four alternating Pre-Programmed massage techniques that automatically switches to the next technique after five minutes with three levels of intensity and auto stop feature.

8. The Vibrating, Massaging Sneakers as is claimed in claim 2 is created with an extra inner lining designed to be Pockets for the maneuvering of Air flow, and is equipped with an Air Compression/Acupressure Motor that is located in the Therapeutic Compartment, and is used to inflate/deflate the Air Pockets behind the Sneaker's inner lining.

9. The Vibrating Sneakers as is claimed in claim 4 provides wrap around Air Compression/Acupressure that inflates and deflates, beginning slowly and gradually increasing to the strength of the desired setting and is comprised of up to four different Settings that supplies the surrounding inner surface of the sneakers from the sole of feet up above the ankles with added massaging pressure.

10. The Vibrating, Massaging Sneakers as is claimed in claim 4 is equipped with a Rolling/Kneading element that is located in the Therapeutic Compartment, and consists of a Bi-Directional wavy element which holds and supports the Ball rolling elements which has multiple Bi-Directional rotating massage heads that provides full-coverage massaging pressure to the sole of the feet, from heel to toe and encompasses up to four levels of intensity and up to six choices of motions.

11. The Vibrating, Massaging Sneakers as is claimed in claim 4 has a Percussion feature that utilizes the Bi-Directional element to move in an Up and Down hammering motion with up to twelve percussion heads (up to six in each Sneaker) and three setting adjustments for deep penetrating percussive therapy.

12. The Vibrating, Massaging Sneakers as is claimed in claim 4 is built with lead wires from the massaging adjustment manual selective control unit that operates the stimulating vibration coins, which is placed on the feet pressure point schematic in the Therapeutic Compartment, underneath the sneaker's inner sole.

13. The Vibrating, Massaging Sneakers as is claimed in claim 2 has up to five manual Adjustable speed levels of vibration, up to six vibratory stimulating modes and features gradual vibration ramp-up from initial start to selected manual setting.

14. The Vibrating, Massaging Sneakers as is claimed in claim 1 is equipped with a battery holder that is contained on the back side of the Sneaker, and is energized by a Rechargeable (Lithium Ion Batteries) with up to eight hours of operation per charge.

15. The Vibrating, Massaging Sneakers as is claimed in claim 1 positions the Manual Control unit around the Top Neck portion of the Sneaker which consist of all operable selections, and encompasses both Auto and Manual working abilities, and is also controlled via Wireless Remote Control for portability, and Massage App for modernized Electronic connections.

16. The Vibrating, Massaging Sneakers as is claimed in claim 1 is built with locking devices for connecting to the Mini Sit Down Leg Exerciser Connection that is located along the lower side of the sneakers.

17. The Mini Sit Down Leg Exerciser Connection: as is claimed in claim 3 that interconnects with the Vibrating, Massaging Sneakers, is constructed with a strong, grainy, non-breakable composite material that is a rectangular shape apparatus having two long sides, two short sides, a top layer and a bottom layer, and is comprised of a bottom outer layer created from a thick skid resistant rubber support material that is strong, sturdy and easily cleaned.

18. The Mini Sit Down Leg Exerciser Connection: as is claimed in claim 3 that interconnects with the Vibrating, Massaging Sneakers is equipped with the inter-connectable locking devices for connecting to the Vibrating, Massaging Sneakers, which is located on the Top portion of the device, and consist of up to six height adjustable, compressible spring rods of equal size, that is set inside secure spring holders, in between the upper and lower platforms, that is created with a Collapsible short side to allow for adjustments to the work-out positioning, and with multiple height adjusters in place for securing the changing of position of the exerciser.

19. The Adjustable, Stretchable Hand held Exercising Cords as is claimed in claim 2 is connected to the Mini Sit Down Leg Exerciser Connection that interconnects with the Vibrating, Massaging Sneakers for full body exercise.

20. The Automatically, or Manually Operated Mini Sit Down Leg Exerciser Connection as is claimed in claim 3 is utilized in a Flat Position, or in an Angled Position, Adjusted to various degrees for enhancing the desired muscle conditioning.
